(19) United States
(12) Patent Application Publication
(10) Pub. No.: US 2014/0032306 A1
(43) Pub. Date: Jan. 30, 2014

(54) SYSTEM AND METHOD FOR REAL-TIME SEARCH RE-TARGETING

(71) Applicants: Christopher Sukornyk, Toronto (CA); Christopher Dingle, Toronto (CA); John Timothy Spurway, Toronto (CA); Mazdak Rezvani Abkenar, Toronto (CA)

(72) Inventors: Christopher Sukornyk, Toronto (CA); Christopher Dingle, Toronto (CA); John Timothy Spurway, Toronto (CA); Mazdak Rezvani Abkenar, Toronto (CA)

(21) Appl. No.: 13/997,692

(22) PCT Filed: Dec. 29, 2011
(86) PCT No.: PCT/CA2011/001418

§ 371 Date: Sep. 30, 2013

Related U.S. Application Data
(60) Provisional application No. 61/428,089, filed on Dec. 29, 2010.

(51) Int. Cl. G06Q 30/02

(52) U.S. Cl. CPC G06Q 30/0269
USPC 705/14.43

(57) ABSTRACT

A computer network implemented system and method for managing an Internet advertising campaign is provided. The method includes the steps of identifying, generating, or obtaining attributes of an ad campaign including keywords and optionally including consumer attributes (“ad campaign data”); establishing a consumer profile for each of a pool of consumers, the consumer profile including recent search history obtained on an anonymous basis; comparing the ad campaign data to the consumer profiles so as to identify a consumer audience segment; and bidding real-time for access to display advertising impressions associated with the consumer audience segment so as to enable re-targeting of the consumer audience segment based on the ad campaign data using display advertising. The system includes a data logging utility, a re-targeting utility and a real time bidding infrastructure. A novel real time bidding method is also provided.

### FIELD OF THE INVENTION

This invention relates generally to the area of Internet marketing, and more particularly to performance based Internet marketing.

### BACKGROUND

Online advertising has seen phenomenal growth over the last few years, growing hand-in-hand with the expansion of the Internet. It has evolved from randomly displayed, passive advertisements to advertisements targeted to specific individuals based on their demographic and in some cases psychographic profiles.

Internet advertising generally enables recognizing an audience by identifying prospects of unmet needs and evaluating the environment within which the audience exists. Prior art Internet advertising technologies enable the identification and evaluation of market segments, and development and implementation of strategies to target audiences by positioning and developing messaging as well as choosing appropriate Internet media placement and buys. Various platforms and tools exist for developing and managing Internet advertisement campaigns. More advanced platforms enable for example the development and execution of sales-related feedback, analytics tools for generating for examples sales-related analytics, as well as the optimization of advertising campaign attributes based on performance of the Internet advertising campaign based on campaign objectives for example.

These various Internet marketing campaign methods, and platforms that enable their design and implementation, generally rely on search engine marketing or SEM, in which Google AdWords plays a dominant role. Google has been one of the viable solutions to acquire new leads for performance marketers. Due to its effectiveness, this acquisition channel's limited inventory has become increasingly over-subscribed resulting in unfulfilled campaigns and high bid prices for most popular keywords. For advertisers this means restricted business growth, and high CPAs (costs per acquisition) for popular keywords that erode margin. In other words, Internet performance marketing currently relies heavily on targeted advertising based on matching of displayed ads to search terms entered into search engines.

Performance marketers have explored display ads as an alternative (i.e. display of ads on websites visited by Internet users). However the right to place ads on websites, especially popular ones, generally involve the purchase of significant blocks through channels that are relatively complicated to use in a way that provides desirable return on investment. For example, performance based Internet marketing campaigns generally involve the use of ad networks and non-RTB (real-time bidding) exchanges, in a manner known to those skilled in the art of Internet advertising. A skilled reader will appreciate that use of these tools in connection with performance based marketing generally requires the use of fairly sophisticated creative advertising resources, and also prior art methods and platforms generally are only able to deliver conversion rates for direct advertising that are significantly lower than those provided by SEM ads due to the lack of search intent targeting. As a result, despite great interest, there are relatively few sophisticated advertisers that are achieving an SEM-like ROI from display inventory.

Consequently, search engine landing pages account for less than 5% of all Internet page views, yet search engine marketing (“SEM”) advertising generates greater than $15B in annual advertising revenue. The other 95% of Internet page views (referred to as “non search engine pages” or “general web pages” in the present disclosure) are the domain of display advertising and generate a mere $6B in annual advertising revenue. This stark difference is due, in no small part, to the relative effectiveness of search intent targeting.

As a result, retailers and SEM's are seeking new marketing channels to connect their products with qualified new, current and past consumers such as online shoppers.

Prior art solutions are known for enabling targeted ad display on general web pages. These include for example (i) Targeted/Audience Platforms (ii) Brand DSP's (iii) SEM Bid Management platforms, (iv) Sophisticated Search Agencies, and (v) Search data providers.

Examples of companies that have solutions that enable targeted display ads in general web pages include Buysight, Simpli.fi, and Criteo.

Generally speaking, placement of web ads happens through an ad exchange platform. An important innovation to ad placement is the arrival of Real Time Bidding (RTB) platforms that enable participants to bid the appropriate price on only the impressions where the associated data matches an active campaign. Prior to RTB, media buying was done in bulk at an averaged price, with no knowledge of the past search history of the users that would view each impression.

Various ad serving services are known. These are used for example by advertising agencies and media companies to allow clients to traffic, target, deliver, and report on their interactive advertising campaigns. Google AdX, Admeld, AdBrite, OpenX and others are examples of such services.

None of these platforms directly enable search targeting by keyword, dynamic ads from text, or CPC bidding on real-time exchanges.

Certain publishers have established networks of Internet properties across which search re-targeting is possible. For example Yahoo! operates a network of associated web properties that enable a cookie to be assembled for users based on a search term that matches a campaign and then the targeting that user as they navigate across a set of associated web properties part of or associated with Yahoo!. This means that to serve an impression an individual would have to a) perform a search on Yahoo! that matches an advertiser's set of keywords and b) subsequently navigate to a website that is part of the Yahoo! network. The limitation of the system is that the Yahoo! network of sites has limited reach and so the scale of a campaign is campaign is limited by this scale. There is a need for a technology that enables ad campaigns of a greater scale thus has better reach into key market segments.

Also, prior art solutions generally depend on calculations through large map-reduce jobs and then create a segment into which they place a collection of hundreds or thousands of users they want to target. As a result, in a real-time bidding environment much of the work has been pre-calculated and at by time the bidder needs to only confirm the user belongs to a segment that is “active”. The advantage is that most bids have only 20 ms to make calculations or the ad exchanges will not accept the bid because their goal is to have ads that instantly appear with no visual delay. However the disadvantage is that you cannot update a segment regularly to take into account new information and therefore new information must be processed in large off-line jobs. Particularly with search data, time is of the essence because the efficacy of search data declines rapidly with age. Someone searching for “flights to NY” is more likely to make a purchase in the next hour rather then 1 day from now. Because the invention does not make heavy use of pre-processed segment based data we can rapidly respond to new data in real time. The invention relies on the bidder doing the processing and matching work within the 20 ms time allotment. The challenge is that 20ms does not give significant time to process data—however it does mean the Invention is flexible and any “feedback” or new data into the system can be instantly incorporated in the very next bid request.

There is a need for a method and platform that enables category based targeting of display ads but in a way that addresses the disadvantages above, and also meets the requirements of performance marketers as explained above.

What is needed is an improved system and method for providing performance based Internet advertising using display ads rather than ads directed to search engine pages.

### SUMMARY

The present disclosure relates to a computer network system and computer network implementable method for enabling a promoter to target a specific individual based on their past search history. The system and the method of the present invention involve (a) a method of collecting the past search history, and (b) based on the collected search history information initiating real-time bidding directed to a consumer audience segment defined based on (a).

The present invention enables a performance based marketing system and method for display advertising. Prior to the system and method of the present invention performance based marketing for Internet based direct advertising was not possible.

In this respect, before explaining at least one embodiment of the system and method of the present disclosure in detail, it is to be understood that the present system and method is not limited in its application to the details of construction and to the arrangements of the components set forth in the following description or illustrated in the drawings. The present system and method is capable of other embodiments and of being practiced and carried out in various ways. Also, it is to be understood that the phraseology and terminology employed herein are for the purpose of description and should not be regarded as limiting.

In one embodiment the present invention provides for a computer network implementable method for managing an Internet advertising campaign, the method executable on one or more computing devices defining an Internet advertising platform, characterized in that the method comprises: (a) identifying or generating attributes of an ad campaign including keywords and optionally including consumer attributes (“ad campaign data”), and optionally updating the ad campaign data dynamically on an ongoing basis; (b) establishing dynamically a consumer profile for each of a pool of consumers, and storing to the consumer profile on an ongoing basis information collected from external data sources that is relevant to the targeting of the pool of consumers, including (i) recent search history collected by a web platform on an anonymous basis, and (ii) optionally information regarding content of one or more web pages accessed by each of the pool of consumers; and (c) comparing the ad campaign data to the consumer profiles so as to identify a consumer audience segment, and bidding real-time by means of one or more ad networks for access to display advertising impressions in web pages associated with the consumer audience segment so as to enable re-targeting of the consumer audience segment based on the ad campaign data using display advertising, thereby enabling performance marketing on a targeted basis using display advertising.

In a further embodiment the present invention provides for the computer network implementable method for managing an Internet advertising campaign method comprising the further step of dynamically generating a string of keywords for targeting each of the pool of consumers based on the then current ad campaign data and the then current consumer profile(s), the keywords being operable to enable real-time bidding for ad impressions based on the groups of key words

In yet another embodiment the present invention provides for the computer network implementable method for managing an Internet advertising campaign comprising the further step of targeted placements of ads in one or more general web pages and not search engine web pages.

In a further embodiment the present invention provides for the computer network implementable method for managing an Internet advertising campaign wherein the ad campaign data includes campaign objectives, and wherein the method comprises the further step of optimizing one or more attributes of a real-time bid placed through one or more ad networks, in order to improve the success rate of the placement of the ad relative to the campaign objectives.

In yet a further embodiment the present invention provides for the computer network implementable method for managing an Internet advertising campaign wherein the targeting of users based on targeted placement of ads in one or more general pages approximates the targeting provided by means of targeted placement of ads in search engine web pages.

In another embodiment the present invention provides for the computer network implementable method for managing an Internet advertising campaign wherein the method permits the targeting of the pool of consumers by means of a plurality of web pages where no prior relationship between the publisher(s) of the web page and the operator of the platform is required.

In yet another embodiment the present invention provides for the computer network implementable method for managing an Internet advertising campaign comprising the further step of initiating one or more of the following steps: (a) validating one or more bid requests received from the one or more ad networks; (b) if the results of validation are positive, then initiating real time bidding operations based on ad group selection and user and/or consumer segment targeting; or (c) receiving feedback from the ad networks as a result of the bids placed and extracting from this feedback information that is used for further user and consumer segment targeting.

In another embodiment the present invention provides for a computer network implemented system providing an Internet advertising platform, the system including one or more server computers connected to an interconnected network of computers, the server computers including or being linked to a server application, characterized in that the Internet advertising platform comprises: (a) an advertising campaign manager that is operable to identify or generate attributes of an ad campaign including keywords and optionally including consumer attributes (“ad campaign data”), and optionally is operable to update the ad campaign data dynamically; (b) a data collection utility that is operable to establish a consumer profile for each of a pool of consumers, and store in the consumer profile on an ongoing basis information collected from external data sources that is relevant to the targeting of the pool of consumers (“targeting information”), including (i) recent search history collected by a web platform on an anonymous basis, and (ii) optionally information regarding content of one or more web pages accessed by each of the pool of consumers; and (c) a re-targeting utility that is operable to compare the ad campaign data to the consumer profiles so as to identify a consumer audience segment of interest, wherein the re-targeting utility is linked to a real time bidding utility that is operable, based on key words generated by the re-targeting utility based on the then current targeting information, and that are optimized for targeting the consumer audience segment of interest, to respond in real time to bid requests from one or more ad networks linked to the platform by bidding real-time for access to display advertising impressions in web pages associated with the consumer audience segment so as to enable re-targeting of the consumer audience segment based on the ad campaign data using display advertising, thereby enabling performance marketing on a targeted basis, using display advertising.

In another embodiment the present invention provides for a computer network implemented system providing an Internet advertising platform wherein the targeting of users based on targeted placement of ads in one or more general pages approximates the targeting provided by means of targeted placement of ads in search engine web pages.

In another embodiment the present invention provides for a computer network implemented system providing an Internet advertising platform wherein the system permits the targeting of the pool of consumers by placement of ads in one or more web pages without a prior relationship between the operator of the platform and the publisher of the one or more web pages.

In yet another embodiment the present invention provides for a computer network implemented system providing an Internet advertising platform wherein the ad campaign data includes campaign objectives, and wherein the re-targeting utility includes or is linked to an analytics engine that enables the automated optimization of one or more attributes of a real-time bid placed through one or more ad networks in order to improve the success rate of the placement of the ads relative to the campaign objectives.

In yet another embodiment the present invention provides for a computer network implemented system providing an Internet advertising platform wherein the server application also includes a scheduler and job dispatcher that is operable to manage the system operations to ensure that the generation of up to date target information, key words, and optimized bids for ad impressions happens within the timing requirements of the one or more ad networks.

In yet another embodiment the present invention provides for a computer network implemented system providing an Internet advertising platform wherein the one or more servers are linked to one or more data stores, and the scheduler and job dispatcher is operable to direct the storing and availability of information to ensure the timely access to require information for the real-time bidding for ad impressions.

### BRIEF DESCRIPTION OF THE DRAWINGS

FIG. 1 illustrates the system and method of the present invention by referring to the entities involved in its implementation or use.

FIG. 2 illustrates the system of the present invention in a representative system diagram.

FIG. 3 illustrates the system and method of the present invention in a more detailed system and workflow diagram

FIG. 4 illustrates an example of the logic of the real-time bidding method of the present invention, in one aspect thereof.

FIG. 5 illustrates a generic system implementation of the computer platform of the present invention.

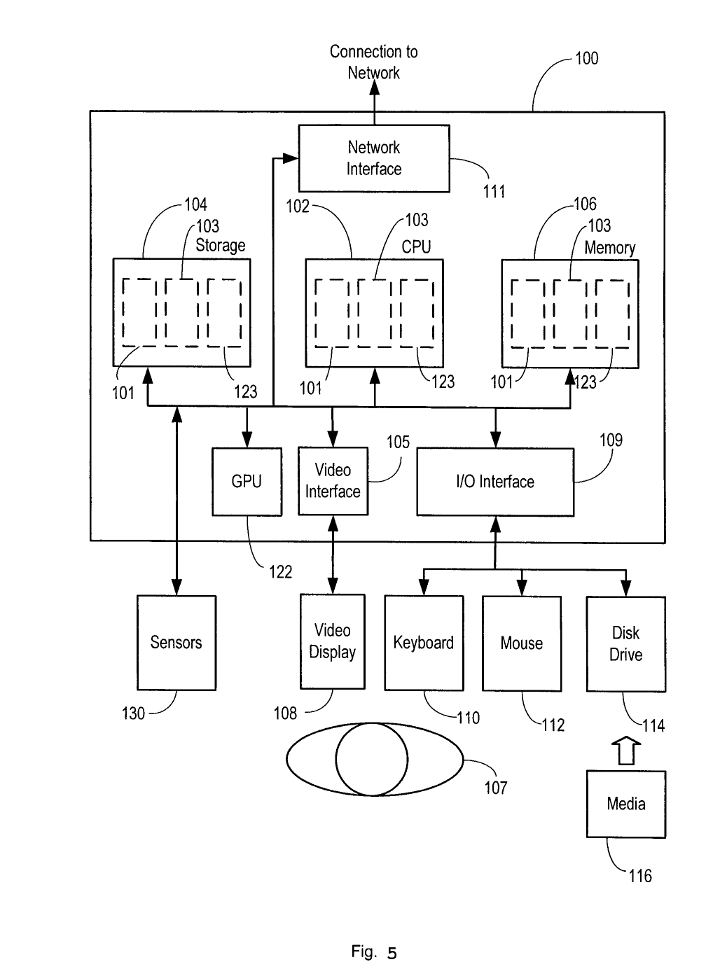

### DETAILED DESCRIPTION

Definitions

The following words, when used in the present specification, have the following meanings:

“consumer' includes any entity, individual or business, to whom messaging (such as advertising) is targeted in accordance with the present system and method is directed; it may be a person, a collection of people, or in other system integration scenarios a consumer may be a machine-based consumer of the information in support of further processing; “consumer” may be used interchangeably with “user”;

“data provider” or “data partner” means any provider of consumer search information (including search history) including content networks, comparison shopping sites, domainers, analytics platforms, and widget providers;

In accordance with the present system and method, content can be utilized for a wide range of purposes as outlined below, whether for a specific commercial purpose such as generating messaging such as advertising or targeting advertising based on a consumer profile, or a more general purpose of enabling a promoter to target messaging in a more effective manner using general web pages.

The system provides a performance marketing platform that enables targeted placement of advertising on non search engine pages, which are referred to as “general web pages” in the present disclosure. The system and method of the present invention enables performance based online advertising campaigns to be conducted in relation to relatively inexpensive display advertising inventory that approximates the targeted aspect of search engine marketing where advertising is placed on search engine pages.

In particular, the system is best understood as an Internet marketing platform that enables performance marketing based on integration of search retargeting solutions, as explained below.

Unlike traditional site retargeting, search retargeting in accordance with the present invention enables the delivery of new consumers to a website that the Internet users (such as consumers) may not have visited before. Based on one ore more data collection methods, the present invention enables the targeting of recent search activity of a large number of consumers for example active on-line shoppers, by placing ads in general web pages, without the requirement that the web pages be associated with the operator of the platform. This allows the campaigns involving targeted advertising to be directed ad a wide range of web pages. Significantly, the platform of the present invention enables the search retargeting in a way that has both advantageous reach and specificity. The platform of the present invention is configured in a way that enable such reach and specificity, but also the speed required by ad networks in order to bid successfully for desired ad impressions. The achievement of the granular targeting possible in accordance with the present invention the optimized bidding constitutes an important innovation over the prior art. Prior to the contributions of the present invention it was generally believed that performance targeting in connection with real time bidding for ad impressions for general web pages was not technically feasible.

A registered advertiser client user of the system the present invention, for example, may upload their keywords, and the system and method of the present invention enables the dynamic creation of a consumer audience segment that matches the customer profile associated with a campaign.

In other words, the present invention enables display advertising to operate in the manner of search engine marketing. More specifically, search retargeting in accordance with the present invention enables advertisements to be directed to suitable Internet audiences relying on search intent.

The computer implemented method of the present invention may be understood as including three distinct phases: (A) data collection, (B) real-time bidding based on collective data and current relevant ad campaigns based on price and impact optimization, resulting in serving of targeted ads to general web pages that may not be integrated with the search retargeting ser, and (C) offline data processing.

In one aspect of the invention, the platform of the present invention is operable to generate dynamically unique “keywords” for each instance of user targeting, which enables the performance of highly granular user-level targeting in addition to “segment”-level targeting which targets a group of users or a category of users. ‘Keywords’ can either be English (or other language) words or unique alphanumeric identifiers called ‘Tag Keywords’. The present disclosure refers nonetheless to the target consumers as a consumer audience segment, and the present invention enables the delivery of content to the consumer audience segment, or such content may be dynamically created and presented. For example, based on the dynamic creation of the consumer audience segment, dynamic display ads may be served to the consumer audience segment in a targeted manner based on intersection between the keywords and other attributes of the ad campaign and the consumer audience segment.

The placement of the content to the consumer audience segment may be secured based on PPC pricing in connection with operation of a real-time bidding engine. CPM, CPA and other forms of pricing area may also be supported.

One advantage of the present invention is that it provides strong probability of a conversion from the placement of the ad to a purchase (based on the improved targeting that results from re-targeting enabled by the present invention), at a relatively affordable price based on the favorable cost of display advertising in comparison to search engine advertising.

In a particular implementation of the present invention a user of the performance marketing platform of the present invention (for example an advertiser engaged by a brand interesting in deployment of: (1) imports keywords to the performance marketing platform, for example from an existing SEM keyword list from AdWords, and optionally other information related to an ad campaign such as desired consumer profile information (“ad campaign data”); (2) the ad campaign data is matched against recent search history for a pool of consumers, collected anonymously, for example by operation of one or more systems associated with data providers, and linked to the performance marketing platform of the present invention, so as to identify a consumer audience segment, and (3) dynamic display ads are served across one or more ad exchange engines linked to the system of the present invention, through a real time bidding infrastructure included in the system of the present invention, based on the ad campaign data (and particularly the keywords) but targeted to the consumer audience segment through placements of ads in general web pages visited by members of the consumer audience segment.

Specifically the real time bidding infrastructure is operable to monitor available impressions across multiple platforms and ad exchanges so as to identify impressions of interest based on intersection with the consumer audience segment.

The re-targeting of consumers in accordance with the present invention may occur as follows:

(1) a consumer engages in an Internet search using a search engine such as GOOGLE™ YAHOO™ or BING™, (2) the consumer engaging in the Internet search is logged by the system of the present invention, for example in co-operation with the data providers associated with the system of the present invention, so as to generate logged data for the consumer in a database, (3) the system of the present invention re-targets the consumer after it has left the search engine pages based on the logged data using display advertising, and (4) if the consumer clicks on the display advertising the consumer is directed to one or more web pages associated with the promoter of the display advertising.

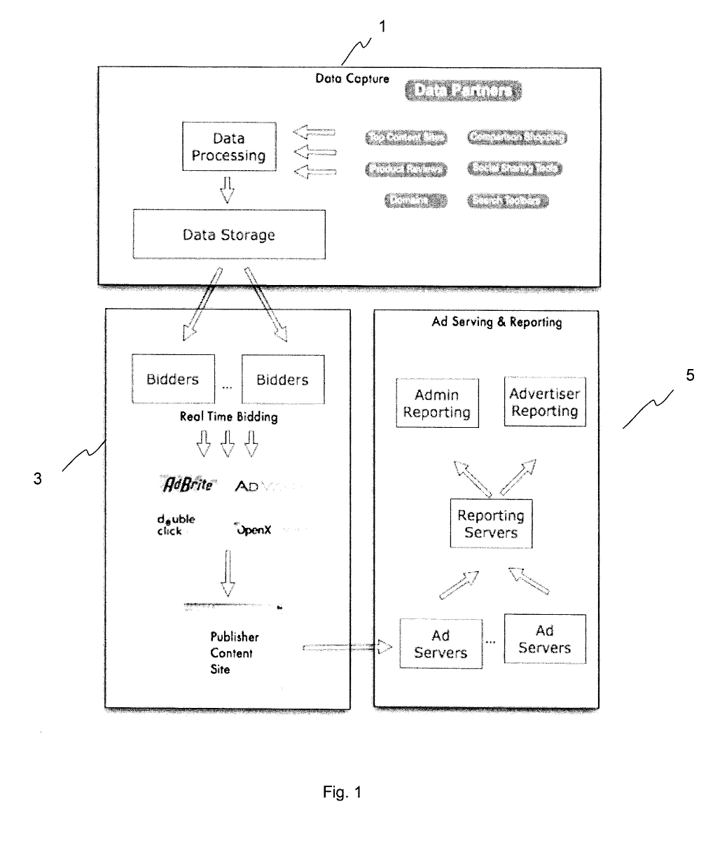

The method of the present invention, as explained above, can be understood by referring to FIG. 1. One or more processes provide data capture 1 or data collection, which enables real time bidding for ads 3, and ad serving and reporting 5. FIG. 1 illustrates a representative implementation of the method of the present invention. Data collection 1 may rely on, for example, data partners who may provide consumer search data based on top content sites, product reviews and the like. The search data provided by data collection 1 is used to support real time bidding for ad impressions, as explained in detail below. Then based on the results of real time bidding, ad serving and reporting 5 is initiated. As shown in FIG. 1, the use of third part ad exchanges is contemplated for the real time bidding 3 aspect of the present invention.

In a further aspect of the present invention, the system may provide automated or support services from a human that enable the targeting of consumer audience segments with particular attributes including demographic data, location data, and other data. The automated or human support services may also extend to generation of specific content, including by leveraging a variety of third party tools that may include semantic generators for enabling the generation of content that is relevant based on the keywords.

The advantages of the present invention include:

(1) Providing a new solution for search marketers to reach prospective customers through general web pages on a PPC, keyword targeted basis as they do currently using for example AdWords™

(2) Cost per acquisition rates that meet the requirements of advertisers and other promoters.

(3) The solution of the present invention provides strong return on investment by providing effective targeting of consumer audience segments.

(4) The solution of the present invention is easy to use, and integrates with existing platforms and engines.

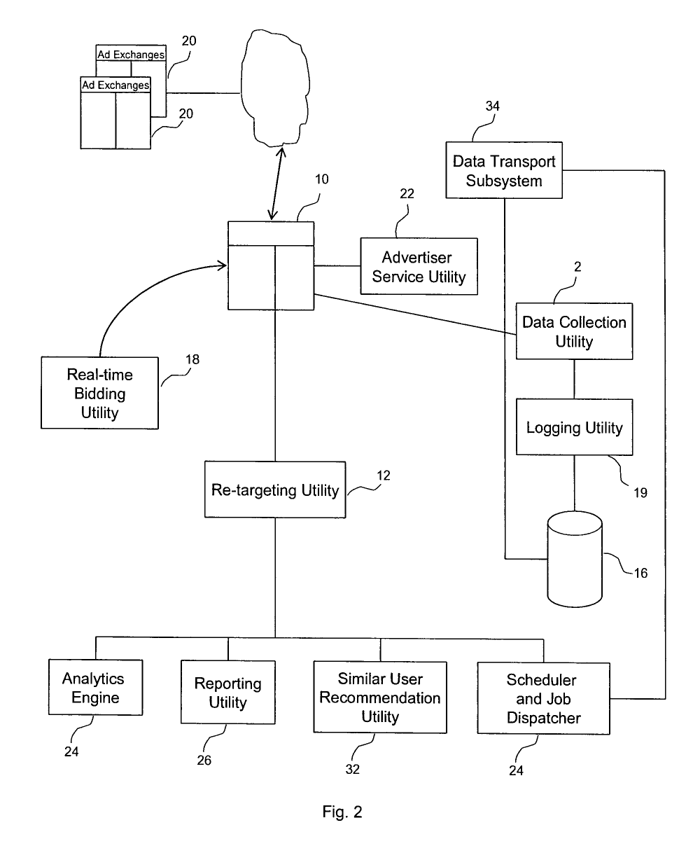

In one implementation of the present invention the performance marketing platform 2 of the present invention is best understood as being implemented using one or more network-connected computers that include or are linked to (1) a data collection utility 4, (2) a re-targeting utility 12, and (3) a real time bidding utility 18, as illustrated in FIG. 2.

FIG. 2 illustrates a networked implementation in accordance with an illustrative embodiment of the present system and method. A web server 10 is illustrated for making the resources of the system of the present invention available via the Internet. In one embodiment, the web server 10 is linked to one or more server applications that are operable to provide the platform functions described in this disclosure. The data collection utility 4 may be implemented so as to include the logging utility 14. The logging utility 14 enables the capture and logging of the recent search information for an Internet user of interest. The logging utility 14 enables the storage of the logged recent search information data to the database 16.

The re-targeting utility 12 enables the re-targeting of consumers based on the logged data, as further described below. The system of the present invention may incorporate an ad exchange or may be linked to one or more ad exchanges 20. The system, in one implementation thereof includes a real time bidding utility 18 that provides or links to the real time bidding infrastructure enabling the monitoring of display ad impressions, and real time bidding for display ad impressions that intersect the with the consumer audience segment defined as explained. It should be understood that the re-targeting utility 12 and the real time bidding utility 18 connected to ad exchanges 20 provide a bidding infrastructure for implementing the bidding operations referred to below. These components together may be referred to as a “bidder infrastructure” in the disclosure below.

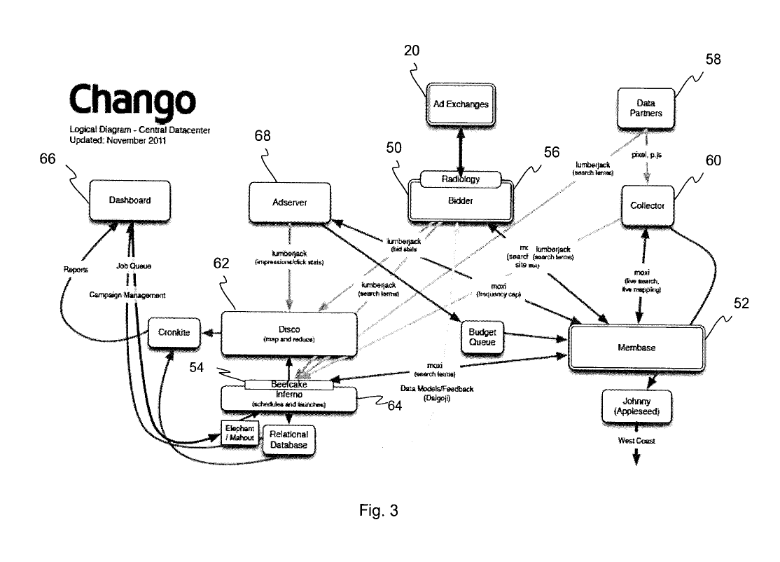

FIG. 3 illustrates the system and method of the present invention using a more detailed system diagram that also illustrates a possible workflow in accordance with the present invention.

It should be understood that the system of the present invention may optionally also include an advertiser service utility 22 that is operable to provide access to a variety of advertiser directed services such as content creation, support in defining the parameters of the consumer audience segment, analytics services, reporting services and the like. These services may be provided by relying on third party technologies by integrating third party technologies into the system of the present invention, or by integrating third party services in the offerings of the operator of the system of the invention, by reselling third party services by operation of the present invention. Further details regarding possible aspects of the advertiser service utility 22 are provided below.

It should be understood in the present disclosure that the functions provided herein may be performed by different entities. Additionally, the various functionalities of the present system and method can be distributed across a plurality of different computer systems.

In the present disclosure, the full implementation of the system and method on a distributed and networked computing environment is also described. This includes implementation of the system and method based on Internet-based technology development and service development wherein users are able to access technology-enabled services “in the cloud” without knowledge of, expertise with, or control over the technology infrastructure that supports them (“cloud computing”). Internet-based computing further includes software as a service (“SaaS”), distributed web services, variants described under Web 2.0 and Web 3.0 models, and other Internet-based distribution mechanisms. In order to illustrate the implementation of the present system and method in such distributed and networked computing environments, including through cloud computing, the disclosure refers to certain implementations of the system and method using multiple sets of computers. It should be understood that the present system and method is not limited to implementation on any particular computer system, architecture or network. It should also be understood that the present system and method is not limited to a wired network and is implementable using mobile computers and wireless networking architectures.

Typically, at least one set of computing devices would generate or retrieve and send the keywords over the network to a second set of computing devices to collect and store the logged data, which is then used by the re-targeting utility as described above. The re-targeting utility co-operates with the real-time bidding utility, which in turn co-operates with at least a third set of computing devices for enabling the real-time bidding for ad impressions that are used to re-target the consumers that are part of the consumer audience segment.

As described in further detail below, the present system and method may include a feedback loop from the content that is placed by operation of the system so as to enable the assessment of the performance of content placed by operation of the present invention. The system of the present invention may be adaptive to the performance report so as to enable for example improvements in performance over time.

The consumer information may be consumer driven or machine driven. For example, consumer information may include, in addition to the search history referenced, consumer input provided via a user interface, consumer demographic information, consumer browsing information, machine generated data, GPS data, sensor data, or any combination thereof. The consumer input may be provided in response to a web based search query.

Data Collection

Data collection of search data is required to identify the consumer audience segment of interest for a particular campaign associated with the performance marketing platform of the present invention. The data collection utility 2 of the present invention, and the logging utility 14 that is part of the data collection utility 2 is operable to enable collection of data in support of the search retargeting operations of the present invention.

The data collection mechanisms of the present invention enable the deliver of the data to web server 10 relying for example a consumer client-side method.

The logging utility 12 is operable to collect data using one or more different mechanisms. For example, the search re-targeting may utilize one or more of: (A) client-side data collection (using a consumer's web browser), (B) web server logs, and (C) real-time data collected through the bidding process. The data collection may relate to the user, the content of relevant pages, or a combination of both as explained above. The performance marketing platform 2 of the present invention is operable to utilize direct search histories of the users, as well as recommend sites, and search terms based on machine learning algorithms and other techniques described below.

The consumer's web browser may be provided a JavaScript code for example that enables the extraction of search data the HTTP REFERRER header that is passed to the page from the source of the traffic, i.e. the search engine page from which the user was re-directed. The JavaScript code forwards the “document.referrer” data to the web server 10. The client-side JavaScript code allows for example sites with their own search engine to specify search terms that are not part of a standard search engine query to be collected by the platform of the present invention.

Alternatively, another method of integration with content publishers is to receive their web server logs, which include the page URL and the referrer URL, as well as the unique user identifiers, as further described below.

Regardless of which client-side method is used, at the time of search term collection, each user may be assigned, in one aspect of the invention, a Universally Unique Identifier (UUID) and that information is stored in the user's browser as a cookie for an extended period of time. This unique identifier enables the association of the unique user with a set of search terms to enable granular targeting enabled by the present invention.

In case of the use of web server logs, a secondary process may be required to map the UUID assigned to the user by the partner with the search retargeting engine. This process, termed “cookie mapping”, involves serving a HTTP request, normally in form of a transparent 1×1 image pixel that performs a redirect (HTTP Code 302) operation to a server of a partner of the operator of the platform of the present invention (“partner”), and a second redirect from the partner back to platform of the present invention for final mapping. A JavaScript library implemented on the database 16 may keep track of matched partners as to not create duplicate mappings and cause excess load on the servers on either side.

In the process of processing search data, the platform of the present invention is operable to generate statistical data about the keywords, and optionally the partners. These statistics can be used to provide keyword-level match information for advertising campaigns implemented by operation of the present invention (“campaigns”). The log of all keywords collected may also be transported for detailed analysis and report generation to a platform component of the present invention, for example a Map/Reduce cluster based on the Open Source Disco project (www.discoproject.org). The resulting information may be used for example to perform successfully on future campaigns. More information about the Map/Reduce system can be found below.

The primary technology responsible for associating search data with unique consumers, in one implementation is implemented as a flexible rules-based system that allows the receipt and processing of different file formats (including those generated by data partners), and from information obtained by the system (for example from data partners) the extraction of search data and also in addition optionally geographic information, so as to enable the generation of unique consumer information from the search data and also optionally the geographic information.

In the process of processing search data, the data logging utility 14 is operable to generate statistical data about the keywords, and optionally also about the data partners. This statistical data provides keyword-level match information for ad campaigns. A log of all keywords collected is also transported for detailed analysis and report generation to the logging utility 14.

It is important to note that to provide the advantages of the present invention, it is necessary to enable the access of search data in real time or in very near real time, so the search data may be stored in database 16 implemented as a high performance, low latency, memory-based key-value database system that forms part of database 16.

The logging utility 14 in one aspect of the invention may also incorporate or be linked to a robust system for log transport, as further explained below. These logs are either generated by components internal to the system, or uploaded from data partners. A common log transport technology may be used which handles real-time detection of new log files through a rules-based system to perform log transformation, and transportation. This system component is operable to move files from one server to the other (or even across the Internet, on Amazon S3, etc.), perform file compression, and upload files to the Disco Distributed File System (DDFS), used in one implementation of the present invention.

The system of the present invention may be operable to monitor the file system for certain patterns and to perform the required actions based on a series of rules embodied in the logging utility 14. The logging utility 14 may be configured to establish and store to the database 16 a consumer profile which may be updated from time to time. Based on the consumer profiles, the re-targeting utility 12 is operable to define the consumer audience segment, also based on the ad campaign data.

The logging utility 14 is also operable to handle error cases and respond appropriately.

Real-time Bidding Utility

As explained above, the present invention, in one implementation thereof also includes real-time bidding utility 18 that enables the re-targeting of consumers after they leave the search engine pages by bidding in real time on display ad impressions based on the matching of the ad campaign data and the consumer profiles by operation of the re-targeting utility 12. More particularly the real-time bidding utility 18 enables bidding in real-time on associated display ad impressions using either an ad exchange of the operator of the system of the present invention, or by connecting to third party ad exchanges by means of the real time bidding infrastructure which may be implemented as part of the platform of the present invention.

Real-time ad exchanges may be linked to the platform of the present invention and may be “partners” of the operator of the platform of the present invention. The bidder infrastructure that is part of or linked to the platform of the present invention is configured to process “bid requests”, and the bidder infrastructure may be operable to decide whether to participate in an auction by bidding on the request.

Real-time bidding is generally implemented by consuming API requests from real-time ad exchanges. Generally speaking, ad exchanges connect to the bidder infrastructure and provides to the bidder infrastructure bid requests. The real time bidding utility 18 of the present invention determines whether to pass on the bid request, or participate in an auction for an impression, and if the decision is made to participate, calculate optimal bid price for wining the bid but optimizing profitability.

The bidding process as implemented in a particular aspect of the platform of the present invention is generally latency sensitive, with most exchanges capping at around 100 milliseconds; therefore, it is important to ensure that data access is fast, and resource efficient. Each bid request goes through several stages to determine its suitability, and it is generally dropped in the process at the earliest possible point. This ensures that time is not wasted on requests that will not result in a successful conversion. In order to further improve response times, data that is not refreshed often is stored directly in memory, making it available for fast access. However, the amount of available consumer search data may be beyond the memory limits of any single machine and is therefore stored in the previously mentioned Membase data store. Due to its design, the Membase data store holds all available data in RAM for fast access, while persisting it to disk for disaster recovery. It should be understood that the system of the present invention may be modified or extended to include various hardware, software, or middleware elements to further increase the speed of the operations described.

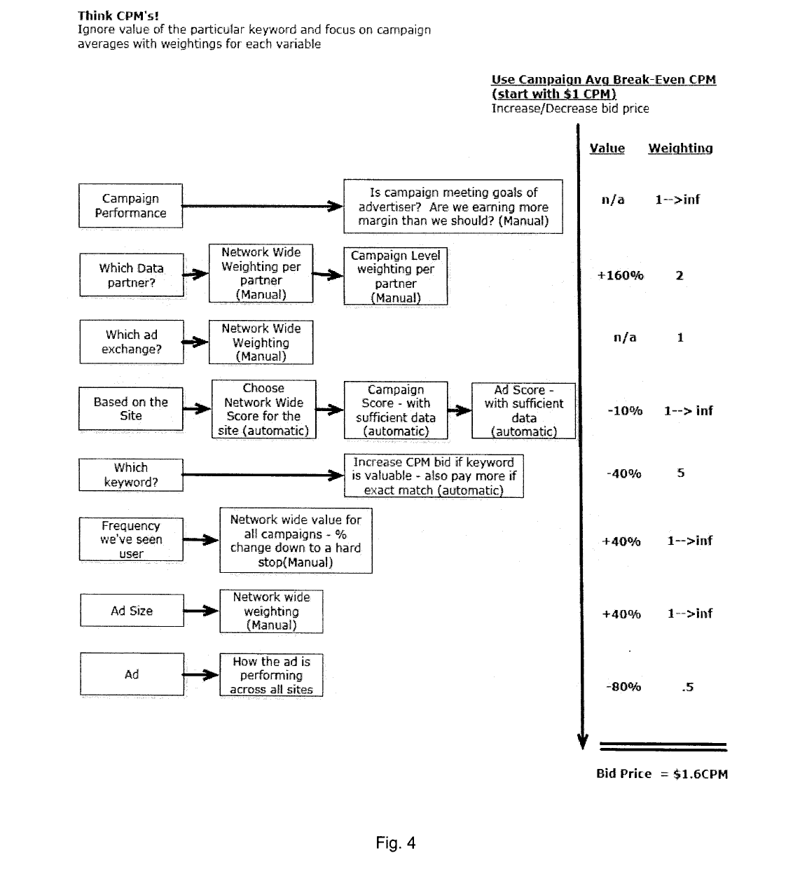

In one aspect of the present invention, the real time bidding utility 18 of the present invention is operable to implement a particular mechanism for optimizing the likelihood that an ad impression is likely result in a conversion. The real time bidding utility 18 in one particular aspect thereof may implement a real-time bidding algorithm that combines past performance of each campaign, as well as global campaign performance, with information about the search data (age, source site, source partner), and the site from which the bid request originated, to decide whether this impression is likely to result in a conversion. The real time bidding utility 18 is linked to the analytics engine 24 through the re-targeting utility 12 in order to enable the calculation of a bid price that is likely to win the auction for the impression, but still result in a profit margin. FIG. 4 illustrates representative logic implemented by the performance marketing platform of the present invention in order to optimize bid price relying on analytics engine 24.

The performance marketing platform of the present invention is operable to: (1) receive one or more bid requests; (2) initiate one or more processes for validating bid requests, as explained above; (3) if the results of bid request validation are positive, then initiating real time bidding operations including for example ad group selection and user and consumer segment targeting as explained below; (4) ad serving and feedback operations including for example reporting on ad serve results, and extraction of further user and consumer segment targeting information.

Bid Validation Techniques

In another aspect of the real time bidding utility 18, it may initiate the following operations to determine whether to continue with the bidding, relating to validation of bid requests:

(A) Check for existence of a valid UUID. Requests without a valid UUID are rejected unless any of the conditions below are satisfied: (i) If a valid search term is contained within the bid request. The page URL and/or the referring URL are parsed for standard patterns that indicate search. Example: q=<term>, search=<term>, or keyword=<term>; and (ii) Check to the see if the page URL is being marked for page-level targeting. (See “Targeting Strategies” below for details).

(B) Check the user's IP Address and a suitable User Agent blacklist database to ensure the current user is not a bot, or blacklisted for fraud or other reasons.

(C) Verify that the ad size being requested is one of the supported IAB ad sizes.

(4) Verify that the site is not blacklisted. This check is nullified if a site is globally blacklisted, but separately white-listed by an individual campaign.

The bidding process generally results in the following output: (1) statistical data, and (2) newly discovered search data. The statistical data contains information on every incoming bid request, plus additional information on bid requests that were rejected, as well as those that were bid on. This statistical data is provided to the analytics engine 24 to support platform operations, including for example the further optimization of bids made by operation of the system of the present invention.

The output from the bidding process may be written to log files that are transported into DDFS for processing by the data logging utility 14. Additionally, some real-time ad exchanges provide HTTP REFERRER data that can be detected by the system of the present invention and used to participate in the real-time bidding process, while also being stored for future reference. Logs generated by the system of the present invention are transferred to the logging utility 14 for processing.

The real-time bidding method and system of the present invention combines past performance of the various parts of the system, with information about the source and age of search data, as well as information provided by the advertiser per campaign, and per keyword to produce a bid price that is likely to win the auction, while maintaining profitability.

At fixed intervals, the bidders (as illustrated in FIG. 3) may query one or more data warehouse systems (such as for example a data warehouse implemented using GREENPLUM™) to gather results of past performance for various components of the system. The bidding utility 18, in one implementation thereof, cooperates with the analytics engine 24 looks at the following variables, and initiates one or more system operations that may implement for example a range of algorithms that enable for example the determination of the “word” of a particular ad impression, and based on this a system generated bidding price that optimizes profitability as illustrated in the description below.

The real-time bidding utility 18 of the present invention is configured to continuously process parameters related to all active campaigns registered with the performance marketing platform 2 of the present invention, and optimize the performance of these campaigns based on output from the analytics engine 24. Performance of a campaign is generally defined by the advertiser as either cost per click (CPC) or cost per acquisition of new users (CPA). The system implements one or more algorithms for optimizing the outcomes from ad impression spends realized through the platform of the present invention.

The system operations may utilize the following information elements:
Network-wide click-through-rate (CTR) for the past 60, 21, and 3 days
Keyword CTR for the past 21 days
Advertisement (creative) CTR for the past 21 days
Site (domain name) CTR for the past 60 days
Ad Exchange CTR for the past 21 days
Data partner (source of original search data) CTR for the past 21 days
Age of the original search term (applied against a decay formula)
The value of the keyword specified by the advertiser
Margin holdback amount per Exchange

To ensure reasonable limits, each of the following factors may be limited in the bidding utility 18 by a specific minimum and maximum value.

In order for there to be sufficient data a minimum sample size may be determined for each data element by the system of the present invention, for example 25,000 impressions. The minimum sample size and collection period, for example 21 days, may be varied by the analytics engine 24 based on a statistically relevant sample set size.

The above variables may be combined by the analytics engine 24 for example using a cascade equation to determine the media bid price offer for the ad exchanges 20. If a particular variable doesn't have enough data to be considered it may be either blended with a parent hierarchy variable or dropped from the calculation, in another aspect of the analytics engine 24.

The decay model for the age of the keyword expression attributed to a particular user and collected from a specific Data Partner may take the following form: y=b*exp(m*x). Where X is the time in days and the coefficients B and M are best fit as determined from the data. Other decay models can be substituted.

A suitable statistical model may be used for determining sufficient sample sizes, and may be implemented to the analytics engine 24.

Ad Group Selection

Ad Group Selection, is one example of a real time ad bidding operation enabled by the platform of the present invention. If the initial checks of the bid request reveal no problems, and a valid search record is discovered, the bidding infrastructure 30 is configured to attempt to select ad groups (child objects of campaigns) that match the user's records against keywords targeted by all active ad groups in the system.

The keywords may be stored in a tree data structure with edges that are part of a keyword, emulated in a key-value store. The keys part of this store may be groups of ‘words’, and the values may contain a sub-tree containing more ‘words’ and more branches. These keywords not only map to actual words in the English (or other languages), but to special “tag” keywords that are created by the system to represent URLs, categories of users, segments of users, and other uniquely identifiable features that can be targeted in real time.

After the initial selection is complete, the list of campaigns may be further narrowed down by checking for geo-targeting, frequency cap (maximum number of impressions per user per fixed period of time), campaign budget, site white/blacklists, hour-level targeting, data source white/blacklist, above the fold (ATF) or below the fold constraints, and brand safety constraints.

Targeting Strategies

The retargeting utility 14 linked real time bidding utility 18 linked to the analytics engine 24 also enables a plurality of novel targeting strategies that enable performance based targeting in relation to general web pages, as mentioned above.

As explained above, the performance marketing platform 2 establishes the suitability of an incoming request for targeting based on either the user, the content of the page, or a combination of both. The performance marketing platform 2 of the present invention is operable to utilize direct search histories of the users, as well as recommend sites, and search terms based on machine learning algorithms and other techniques described below.

Some of the targeting strategies rely on additional first party data sent to the platform via data collection tags (pixels) known as Optimization Pixel, and Conversion Pixel.

User-level Targeting

The performance marketing platform 2 of the present invention, and more particularly re-targeting utility 12 of the present invention is operable to enable user-level targeting, relying on one or more of the following techniques, embodied in the system of the present invention.

Search History

User search terms that are collected through the data partner network, or the bidding process, are looked up for the incoming user UUID and then matched in either Exact, or Phrase mode to target users or user groups (See “Ad Group Selection”).

Recommended Search

The UUID vector described above may be used to find a set of search terms that is common among converting users, but not as common in the general population. The retargeting utility 12 of the present invention may be operable to generate a set of recommended keywords that is added to the relevant campaign.

Another complimentary source of data is the “Optimization Pixel”. A machine learning algorithm implemented to the system enables search terms “to be discovered” for example from the advertiser's site, and the system matches the UUID from incoming users with converting users to find out which search terms are most likely to derive conversions for the advertiser.

In a particular implementation of the present invention, during the data import process, incoming words may be inspected for spelling errors, and up to two spelling errors may be forgiven. This allows minor and common misspellings to be allowed in as search terms that would otherwise be ignored.

Similar User (Social)

The retargeting utility 14 may include or be linked to a similar user recommendation utility or engine 32 that is operable to use the browsing, and searching history of users collected from the bid request logs, and data partner logs, and incorporate the classification of the campaigns that the searches would match, and then based on this information identify and deliver segments of users that are more likely to have similar interests. Correlating this list with the list of converters for different campaigns allows user-level targeting of the “social circle” of the converters. Once again, a Tag Keyword is used to uniquely identity those groups of users.

Action Classification

As users perform actions that convey intent, such as clicking on an ad or converting on an advertiser's site, their actions are logged by operation of the logging utility 14 and classified in the database 16 under the categories that are associated with that site. For instance, clicking on an ad for a consumer electronics device classifies the user as a “clicker” for “electronics”, and a “clicker” for “consumer products”, and any other category associated with that particular advertiser. These classifications are stored in the user's profile stored to the database 16 under a unique Tag Keyword.

First Party Data

Advertiser data sent through the Optimization Pixel includes incoming search terms, URL of various pages, and any other custom variables the advertiser chooses to pass in. The platform of the present invention may be operable to target users based on any one of or combination of data sent by the advertiser. This strategy can be used to target users that have been to certain pages on the advertiser site (such as e-commerce product information pages), as well as target users based on custom values passed in by the advertiser, such as product codes in a user's e-commerce shopping cart.

In addition to targeting individual pages, the user can be targeted for visiting any generic page of the site, or having done a search that would lead that specific page on the site.

First party data can be based on an individual advertiser, or a coop of advertisers that share data anonymously. This “data coop” establishes a circle of data sharing that is anonymous to all parties, but the groups in the coop have mutually beneficial and related data sets. If a member of the coop indicates that their data should be protected from another potential member, an automatic 2 way blacklist is setup between those two members.

Page-level Targeting

The platform of the present invention, through the retargeting utility 12 coupled to the analytics engine 24 is operable to analyze user action results in websites where the combined user activity is deemed relevant to the set of users that are relevant to a particular campaign. In such cases, the system has ability to bid on a particular URL or any sub-URL by targeting a Tag Keyword.

Recommended Sites

Similar to the keyword recommendations, the site visitation history of the converting users, obtained from the conversion pixel, can be compared against the site visitation history of non-converters. The sites (at page level) that are most commonly visited by all converting users can be discovered by the analytics engine 24 implementing for example one or more suitable machine learning algorithms, and then further narrowed down by examining the contents of the page to see if some of the important keywords in the page (see “Real-time Content Discovery”) are found within any active campaigns, using for example a look up operation of active campaign information stored to the database 16. Pages recommended by this system may be assigned a unique Tag Keyword for targeting.

SEO-based Recommendation

One of the rules of Search Engine Optimization (SEO) is the structure the URL of a page uses to represent a hierarchy, and for the URL to contain relevant keywords, including the title of page, as part of the URL (in dash-delimited format). As an example, an article about “health benefits of berries”, could have a URL that may consist of:

http://DOMAIN/health/food/health-benefits-of-berries.html.

Using this knowledge, page URLs that contain similar patterns can be parsed in real-time (as they are being passed in by the ad exchanges through the API that may link the platform of the present invention to ad exchanges), and the extracted SEO keywords can be matched against active campaigns.

Real-time Content Discovery

As mentioned above, in one aspect of the invention, the bidding on a bidding request may be based not only on information regarding the user (such as consumer segment attributes associated with the user), but also on content associated with the web page where a user has landed. As mentioned above, it is important that the speed of the system be maintained, and therefore the present invention takes an innovative approach to real-time content discovery as well. In one aspect of the invention, the page content of every page URL that appears in bid requests may be logged by operation of the logging utility 14 and transported to the system of the present invention, and for example a DDFS (a Distributed File System) linked to the system for content analysis. A web “Spider” linked to the system crawls through the content using for example a distributed computing platform powered by for example a map/reduce system of the present invention, and content that is deemed important may be indexed and made available for real-time look-up during the bid process. For example, in this way important content such as keywords that appear in the “title” and “heading” tags of the relevant pages may be logged to support the operations of the present invention.

Once again, SEO best practices encourage content authors to put important keywords in the title of the page (in the HTML title tag), and they also encourage the heading tags (HTML H1, H2, etc. tags) to contain relevant and important keywords). Every incoming URL is examined to see if it falls within a domain that contains data that matches active campaigns during the bid process.

Offline Data Processing

As mentioned above, in another aspect of the performance marketing platform 2 of the present invention, the system is operable to initiate one or more offline data processing operations. These include for example the updating of pending campaigns, the compilation of search data, the real-time content discovery. As already mentioned above, the platform of the present invention may include a number of aspects that contribute to the real-time or near real-time processing capabilities, which are important to taking advantage of desirable ad serving opportunities, as mentioned above.

In one aspect of the present invention, the system includes a scheduler and job dispatcher 34 that is operable to schedule and manage the various operations described herein. Particularly given the need for speed of operation, reliability, scalability, and other factors, the scheduler and job dispatcher 34 is an important system. The scheduler and job dispatcher 34 may include or be linked to a data transport subsystem 36. The log files that are generated by various internal systems, or uploaded by data partners, may be handled by a common data transport technology, by operation of the data transport subsystem 36 that handles real-time detection of new log files through a rules-based system, and performs log transformation and transportation. For example, the data transport subsystem 36 is operable to move files from one server to the other (or even across the Internet, on Amazon S3, etc.), perform file compression, and upload files to a distributed file system, such as a Disco Distributed File System (DDFS). This subsystem may monitor the file system for certain patterns and perform the required actions (such as compression, decryption, or other required transformation) based on the provided rules. It can also handle error cases and retry or abort.

Statistics from the data collection subsystem and the real-time bidding subsystem (“bidders”) as well as data from an ad server 20 may be initiated by the data transport subsystem 36 for transportation to the distributed file system (DDFS) and processed through a process known as Map/Reduce, an established industry best practice that allows crunching through large log files, and producing summary results.

The scheduler and job dispatcher 34 which is rules based sub-system may work in conjunction with the DISCO™ Map/Reduce framework to process pieces (or blobs) of data tagged with specific meta-data, as shown for example in FIG. 4. The meta-data associated with each blob of data allows it to be used in various Map/Reduce processes or “jobs” without overlap and in a fully transactional manner.

In most cases, the rules embodied in the scheduler and job dispatcher 34 provides mechanisms for the results of the jobs to be summarized to database insert statements (SQL) and stored in a data warehouse (which may be implemented using EMC GREENPLUM™ technology) for future querying.

Statistics from the data collection utility 4 and the real-time bidding utility 18 (“bidders”) as well as data from the ad exchanges 20 may be transported to a distributed file system (DDFS) and processed through the Map/Reduce process.

The scheduler and job dispatcher 34 may interoperate with the DISCO implemented Map/Reduce framework to process pieces (or blobs) of data tagged with specific meta-data. The meta-data associated with each blob of data allows it to be used in various Map/Reduce processes or “jobs” without overlap and in a fully transactional manner.

In most cases, the rules provide mechanisms for the results of the jobs to be summarized to database insert statements (SQL) and stored in a suitable data warehouse.

Advertiser Service Utility

The system of the present invention may include or be linked to a series of utilities that form part of, or provide services to or through the advertiser service utility 22. This utility may include an analytics engine that is operable to analyze the results of re-targeting based on the invention and provide the foundation for improved performance based on re-targeting. A reporting utility 26 may use the output from the analytics engine 24 and other components of the system to provide one or more reports to registered users of the system of the present invention. The advertiser service utility is operable to provide access to a dashboard 66, which is explained below.

Monetization

It should be understood that the present invention may be monetized for example based on a spread between the PPC paid and the CPM (cost per thousand impression) media and data costs of delivering the click by the consumer to the promoter. Subscription based revenue is also contemplated whether for re-targeting services or for services associated with the advertiser service utility for example. Fees for specific services are also possible as well as a percentage of revenue resulting from transactions enabled through the real-time search re-targeting of the present invention. A variety of different revenue models are contemplated.

Monetization may take place upon display of an advertising message within a media representation. Once the media representation is displayed, monetization may also take place after the consumer clicks the message or after an actual purchasing action takes place. Monetization may depend on a combination of transactions or interactions. Monetization may also depend, in portion, on the service of processing of promoted content at the semantic analysis stage. Another form of monetization would be by a CPM model, which refers to advertising bought on the basis of impressions. Further, another form of monetization could come from forwarding performance results and feedback reports to the promoter.

Use Case

The advantages of the method and computer network implemented platform of the present invention is further explained by a use case.

For example, an online retailer that sells high end fashion goods is interested in attracting more likely buyers to their online retail site. Specifically they are interested in finding people that are interested in high end hand-bags from brands like PRADA™ and LOUIS VUITTON™. Using search engine marketing provided by companies like GOOGLE, they are able to target ads to those people searching for “prada deals” or “prada handbags”. This is highly effective, however, people only spend 5% of their time on average searching and 95% of their online time on other sites across the Internet. As a result, despite the fact that search engine marketing is effective, it only has a certain amount of coverage and cannot target people once they leave a search engine.

Search retargeting using the technology of the present invention, however, allows an advertiser to continue to serve ads to users during that other 95% of the time they are on other content sites.

In contrast, it is useful to note that prior art efforts at developing search retargeting solutions suffer from limitation as to their “reach”. In other words, although large publishers (i.e. Yahoo) could offer search retargeting they were limited to the inventory they had available across their own network. This meant that while they have a limited capability to serve ads to users based on their networks coverage. As a result, there is a lack of network scale resulting in challenges in targeting a sufficient number of consumers with an Internet based marketing campaign.

The Invention solves this “reach” issue by connecting through real-time bidding exchanges and therefore is able to see as large an audience as is possible through one integrated system.

The operation of the real-time bidding utility 18, and more particularly the logic operations embodied in the utility, may be further understood by reference to FIG. 4, where the following variables are used for illustration purposes but without the limiting the invention:
Data match including a referral URL only;
Data match including a cookie vs. IP_agent;
Ad creative type: dynamic, customer;
Ad creative size: IAB standard ;
Frequency cap—for campaign;
Ad campaign day part; and
Exchange Second Price Auction difference.

Additional numerical methods may be used. The described framework makes the assumption of a piece wise linear model with boundary limits and a relatively long temporal period.

Further Details of Implementation

The present system and method should not be considered to be limited to the particular network implementation illustrated. The present system and method may be implemented using a distributed and networked computing environment comprising at least one computing device.

FIG. 3 illustrates in greater detail a representative implementation of the present invention. The real time bidding utility 18 may be implemented as a proprietary system component that responds to bid requests sent via the exchanges, shown as the “bidder” 50 in FIG. 3. Bidder 50 may perform a lookup in the Membase 52 component that is operable to retrieve data about the ID of users associated with a given bid request. Bidder 50 may also be configured to write logs (as explained above), which may be analyzed by the BEEFCAKE™ component 54. In the implementation shown in FIG. 3, the bidder 50 also contains the logic to determine when to bid, and how much to bid. In the particular implementation illustrated in FIG. 3, the ad exchanges 20 are third party exchanges, however, the platform components illustrated adhere to one or more web service protocols defined by the ad exchange operators, and also the platform of the present invention is configured to respond to bid requests sent by the ad exchanges 20 to the platform of the present invention.

In the particular implementation of the invention shown in FIG. 3 “RADIOLOGY” 56 refers to a system component that allows the sampling of real-time bid requests and display of real-time information without storing associated data. This component may be understood as part of the real time bidding utility 18 and supports the rapid operations necessary to practice the present invention.

FIG. 3 also shows a representative implementation of the data collection operations described above. The Data Partners 58 in FIG. 3 are third parties that have either installed the JavaScript distributed by the operator of the platform of the present invention, that send the platform of the present invention data in the form of log files for example. In the particular implementation of the data collection utility illustrated in FIG. 3, a web service is supported by the platform of the present invention, which is accessed by the JavaScript of the operator of the platform of the present invention.

Another aspect of data collection is implemented by the Collector 60 component of the present invention which harvests search terms in real-time and inserts them into the user's history stored within the Membase 52. Collector 60 also stores a historical copy in logs which are processed by Beefcake 54.

The Disco component is essentially a map reduce system based on the Disco technology but customized and configured to support the map reduce operations described herein.

An aspect of the scheduler and job dispatcher mentioned above may be implemented by the Inferno 64 component which automatically runs jobs to process data and store that data into our relational database, made part of database 16.

Dashboard 66 may be one or more dashboards that enable for example advertisers to subscribe to access self-serve functions that are supported by the platform of the present invention. For example the dashboard 66 may provide a user interface that enables a client or client designates to design, deploy and optimize campaigns for example by providing access to a series of campaign design templates and controls, a series of reports provided by the reporting utility and supported by the analytics engine (shown in FIG. 2). The dashboard 66 may also enable administrators to upload creative components and define the targeting parameters for the campaign. The dashboard 66 is further operable to enable administrative users to manage client objectives and co-ordinate efforts to focus on accounts that need attention.

FIG. 3 also shows an ad server component 68 which may be implemented as a component of the platform of the present invention and is operable to serve the impressions, tracks clicks and store this data into logs to be processed by the Disco component 62.

The present system and method may be practiced in various embodiments. A suitably configured computer device, and associated communications networks, devices, software and firmware may provide a platform for enabling one or more embodiments as described above. By way of example, a generic computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 130 may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

It should be understood that further enhancements to the disclosed system, method and computer program are envisioned, and without limiting the generality of the foregoing, the following specific enhancements are envisioned.

1. A computer network implementable method for managing an Internet advertising campaign, the method executable on one or more computing devices defining an Internet advertising platform, characterized in that the method comprises:
(a) identifying or generating attributes of an ad campaign including keywords and optionally including consumer attributes (“ad campaign data”), and optionally updating the ad campaign data dynamically on an ongoing basis;
(b) establishing dynamically a consumer profile for each of a pool of consumers, and storing to the consumer profile on an ongoing basis information collected from external data sources that is relevant to the targeting of the pool of consumers, including (i) recent search history collected by a web platform on an anonymous basis, and (ii) optionally information regarding content of one or more web pages accessed by each of the pool of consumers; and
(c) comparing the ad campaign data to the consumer profiles so as to identify a consumer audience segment, and bidding real-time by means of one or more ad networks for access to display advertising impressions in web pages associated with the consumer audience segment so as to enable re-targeting of the consumer audience segment based on the ad campaign data using display advertising, thereby enabling performance marketing on a targeted basis using display advertising.

2. The method of claim 1, comprising the further step of dynamically generating a string of keywords for targeting each of the pool of consumers based on the then current ad campaign data and the then current consumer profile(s), the keywords being operable to enable real-time bidding for ad impressions based on the groups of key words.

3. The method of claim 1, comprising the further step of targeted placements of ads in one or more general web pages and not search engine web pages.

4. The method of claim 1, wherein the ad campaign data includes campaign objectives, and wherein the method comprises the further step of optimizing one or more attributes of a real-time bid placed through one or more ad networks, in order to improve the success rate of the placement of the ad relative to the campaign objectives.

5. The method of claim 1, wherein the targeting of users based on targeted placement of ads in one or more general pages approximates the targeting provided by means of targeted placement of ads in search engine web pages.

6. The method of claim 1, wherein the method permits the targeting of the pool of consumers by means of a plurality of web pages where no prior relationship between the publisher(s) of the web page and the operator of the platform is required.

7. The method of claim 1 comprising the further step of initiating one or more of the following steps:
(a) validating one or more bid requests received from the one or more ad networks;
(b) if the results of validation are positive, then initiating real time bidding operations based on ad group selection and user and/or consumer segment targeting; or
(c) receiving feedback from the ad networks as a result of the bids placed and extracting from this feedback information that is used for further user and consumer segment targeting.

8. A computer network implemented system providing an Internet advertising platform, the system including one or more server computers connected to an interconnected network of computers, the server computers including or being linked to a server application, characterized in that the Internet advertising platform comprises:
(a) an advertising campaign manager that is operable to identify or generate attributes of an ad campaign including keywords and optionally including consumer attributes (“ad campaign data”), and optionally is operable to update the ad campaign data dynamically;
(b) a data collection utility that is operable to establish a consumer profile for each of a pool of consumers, and store in the consumer profile on an ongoing basis information collected from external data sources that is relevant to the targeting of the pool of consumers (“targeting information”), including (i) recent search history collected by a web platform on an anonymous basis, and (ii) optionally information regarding content of one or more web pages accessed by each of the pool of consumers; and
(c) a re-targeting utility that is operable to compare the ad campaign data to the consumer profiles so as to identify a consumer audience segment of interest, wherein the re-targeting utility is linked to a real time bidding utility that is operable, based on key words generated by the re-targeting utility based on the then current targeting information, and that are optimized for targeting the consumer audience segment of interest, to respond in real time to bid requests from one or more ad networks linked to the platform by bidding real-time for access to display advertising impressions in web pages associated with the consumer audience segment so as to enable re-targeting of the consumer audience segment based on the ad campaign data using display advertising, thereby enabling performance marketing on a targeted basis, using display advertising.

9. The system of claim 8, wherein the targeting of users based on targeted placement of ads in one or more general pages approximates the targeting provided by means of targeted placement of ads in search engine web pages.

10. The system of claim 8, wherein the system permits the targeting of the pool of consumers by placement of ads in one or more web pages without a prior relationship between the operator of the platform and the publisher of the one or more web pages.

11. The system of claim 8, wherein the ad campaign data includes campaign objectives, and wherein the re-targeting utility includes or is linked to an analytics engine that enables the automated optimization of one or more attributes of a real-time bid placed through one or more ad networks in order to improve the success rate of the placement of the ads relative to the campaign objectives.

12. The system of claim 11, wherein the server application also includes a scheduler and job dispatcher that is operable to manage the system operations to ensure that the generation of up to date target information, key words, and optimized bids for ad impressions happens within the timing requirements of the one or more ad networks.

13. The system of claim 12, wherein the one or more servers are linked to one or more data stores, and the scheduler and job dispatcher is operable to direct the storing and availability of information to ensure the timely access to require information for the real-time bidding for ad impressions.
